(19) United States
(12) Patent Application Publication
(10) Pub. No.: US 2004/0138960 A1
(43) Pub. Date: Jul. 15, 2004

(54) Online entrusting system

(76) Inventors: I-Linag Lin, Tainan City (TW); Chang-Chi Lee, Kaohsiung City (TW); Chih-Huang Chang, Tainan (TW)

Correspondence Address: BIRCH STEWART KOLASCH & BIRCH, PO BOX 747, FALLS CHURCH, VA, 22040-0747, US

(21) Appl. No.: 10/665,495

(22) Filed: Sep. 22, 2003

(30) Foreign Application Priority Data
Sep. 19, 2002 (TW) 091121518

(51) Int. Cl. G06F 17/60

(52) U.S. Cl. 705/26

(57) ABSTRACT

The present invention provides an online entrusting system comprising a processing controller, a database, a plurality of analyzing modules and a replying means. The processing controller receives and processes a requiring information on an order inputted by a user. The requiring information relates to integrated circuit packages. The database records the requiring information and a schedule information for processing the order. The analyzing modules produce an analysis result about analyzing if the requiring information on the order is attained or not. The replying means responds the analysis result about the requiring information to the user.

### BACKGROUND OF THE INVENTION

1. Field of the Invention

The present invention relates to an online entrusting system, and more specifically, relates to an online entrusting system for processing the requiring information relating to integrated circuit packages.

2. Description of the Prior Art

Modem network systems allows customers and companies to electronically communicate with each other to share and transfer information by computers. The electronic commerce, i.e. the E-commerce, becomes the trend for transaction. Conventional commerce allows a salesman to use a telephone or a facsimile machine to negotiate a business with a customer. The conventional commercial method is so slow and so expensive. The rapidly developed internet has enabled computers to provide an efficient, widely accessible, and secure mechanism for transacting the business by the E-commerce.

A feature of the E-commerce for transacting the business is the capability for integrating the information came from different electrical systems to perfectly process the requisitions of users at real time. The high level processor reduces the cost by processing the manual works according to operate the high level processor. The economized cost can reduce the price for transacting the business and increase the intention of customers and users to transact the business by the E-commerce.

However, the security issues are the most important questions for transacting the business by the E-commerce. Users may worry the personal information such as the credit card number, account being leaked. The business transacted by the business (B2B) type E-commerce may contain the confidential information of a company. If the trade secret is leaked or fetched by others, the company will lose technology or privilege information. At present, most of the information is encrypted before transmission. For example, SSL 128 bits is a typically technology to protect the information from being fetched or leaked.

Further, the limitation of the time and the space for transacting the business by the E-commerce is less and less. However, for example, a conventional entrust system for transacting the business has to analysis the orders or the requisitions of customers before performing any action about the orders or the requisitions by a computer or the manpower. Then, the customers have to wait for receiving the result about the orders or the requisitions many days later. The time and the process for processing the orders and the requisitions is so long and so complex. It is necessary to develop a novel automatic entrusting system to overcome the disadvantages in the prior art.

### SUMMARY OF THE INVENTION

Base on the previous discussion, the object of the present invention is to provide a system for automatically producing an analysis result according to a requiring information, i.e. a packaging information, on an order inputted by a user. The online entrusting system also responds the analysis result to the user.

The present invention provides an online entrusting system. The online entrusting system comprises a processing controller to process an order inputted by a user, wherein the order comprises a requiring information. A database is coupled to the processing controller to store the requiring information and a schedule information. A plurality of analyzing modules coupled to the processing controller produces an analysis result about the requiring information inputted by the user. A replying means responds the analysis result produced by the analyzing modules to the user. Wherein the user communicates with the online entrusting system via internet. The requiring information may includes a substrate type, the die dimension, a package type, the thermal performance, the amount and the type of substrate layers, the number of the input terminals and output terminals, and the pitch between the input terminals and output terminals.

The present invention also disclosed a method for automatically providing online package entrusting comprises:

inputting an requiring information about a semiconductor package by a user;

storing the requiring information in a database;

producing a plurality of analysis results by a plurality of analysis modules according to the requiring information of the order;

recording the analysis results in the database; and

responding the analysis results to the user by a replying means.

### BRIEF DESCRIPTION OF THE DRAWINGS

FIG. 1 is a functional diagram of the system according to the present invention; and

FIG. 2 is a flow chart diagram according to the present invention.

### DESCRIPTION OF THE PREFERRED EMBODIMENT

The present invention discloses an online entrusting system to automatically provide an analysis result about a requiring information of an order being attained or not to a user, wherein the requiring information of the order is inputted by the user. The online entrusting system automatically analyzes everything about the requiring information and responds the analysis result to the user by integrating each element of the online entrusting system and each analysis step of analyzing. While the online entrusting system operates and connects with a high effective server, the online entrusting system operates more effectively to treat and respond the requiring information to the user.

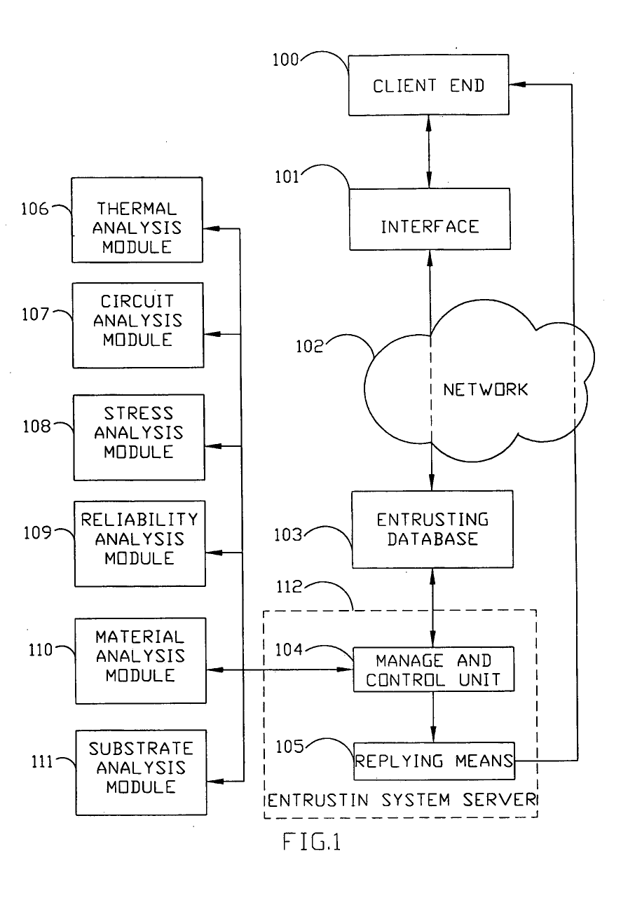

As shown in FIG. 1, the client end 100 may fill the blank on the interface 101 of the present system by a user. The items on the interface include but not limited to the requiring information, i.e. a packaging information, personal information, material and the analysis service including the thermal performance analysis, circuits analysis, stress analysis, reliability analysis, material analysis and substrate analysis. The requiring information includes a substrate type, the die dimension, a package type, the thermal performance, the amount and the type of substrate layers, the amount of the input terminals and output terminals, the pitch between the input terminals and output terminals.

The user or users may select one or more services via the communication interface, i.e. the interface 101. The information will be transmitted to the database, i.e. the entrusting database 103, of the entrusting system and the entrusting database 103 records the order from the client end 100. The entrusting database 103 transmits the order to the entrusting system server 112 that includes a manage and control unit 104 and a replying means 105. The manage and control unit 104 performs the need according to the order and sends related information to the corresponding analysis modules. The analysis modules include the thermal analysis module 106, a circuit analysis module 107, a stress analysis module 108, a reliability analysis module 109, a material analysis module 110 and a substrate analysis module 111. Each analysis module may include a sub-database for recording the analysis records. The analysis result is then forwarded to the manage and control unit 104. Subsequently, the manage and control unit 104 sends the information to the entrusting database 103 and the replying means 105. The entrusting database 103 records the order and the analysis results to prepare for responding the results to the user at any time via different methods, i.e. the network, a e-mail, a facsimile. The replying means 105 may transform the analysis results to an electronic mail format and forward to the user, or the client, via the network. The replying means will send the report about the requiring information and a schedule information to the client end 100 by an e-mail, a facsimile, a short message or something like that. The e-mail system is used for example, not used to limit the scope of the present invention. The schedule information includes the information about processing the order and the result for processing the order.

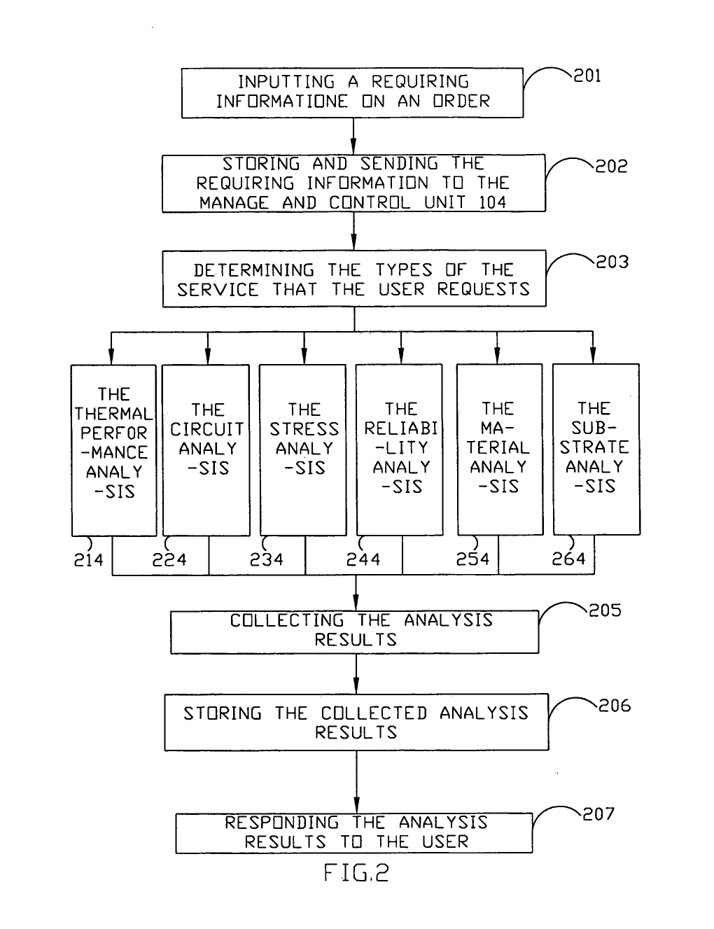

FIG. 2 is a flow chart in accordance with the present invention. The user may login the system and then input the data, i.e. a requiring information, via the network 102, as shown in step 201. As shown in step 202, the entrusting database 103 records the requiring information therein and sends the requiring information to the manage and control unit 104. Then the manage and control unit 104 determines what type the user selected and what service the user requested, as shown in step 203. The manage and control unit 104 controls a plurality of analysis modules to analysis everything according to the requiring information provided by the user. If the requiring information is not certainly or enough to determine what kind of analysis the user wants, the replying means 105 will ask the user to provide more requiring information again, as shown in step 201. The steps 214, 224, 234, 244, 254 and 264 are the thermal performance analysis, the circuit analysis, the stress analysis, the reliability analysis, the material analysis and the substrate analysis respectively.

The analyzing result will be responded to the manage and control unit 104, and then the manage and control unit 104 collects the results as shown in step 205. The manage and control unit 104 stores the requiring information and the analysis results in the entrusting database 103 for inquiring by the user, i.e. the client, as shown in step 206. Subsequently, the stored information will be responded to the replying means 105 to notify the user. The results are responded to the client end 100 in step 207 by the system via the e-mail, the facsimile or the like.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. Thus, while the preferred embodiment of the invention has been illustrated and described, it will be appreciated that various changes can be made therein without departing from the spirit and scope of the invention.

1. An online entrusting system comprises:
a processing controller to process an order inputted by a user, wherein said order includes a requiring information;
a database coupled to said processing controller to store said requiring information and a schedule information;
a plurality of analyzing modules coupled to said processing controller to produce an analysis result about said requiring information being attained or not; and
a replying means responding said analysis result of said analyzing modules to said user.

2. The system of claim 1, wherein said user inputs said requiring information via an interface of internet.

3. The system of claim 1, wherein said requiring information includes a substrate type.

4. The system of claim 1, wherein said requiring information includes a die dimension.

5. The system of claim 1, wherein said requiring information includes a package type.

6. The system of claim 1, wherein said requiring information includes the thermal performance.

7. The system of claim 1, wherein said requiring information includes the amount of substrate layers.

8. The system of claim 1, wherein said requiring information includes the number of a plurality of input terminals and a plurality of output terminals.

9. The system of claim 8, wherein said requiring information includes the pitch between said input terminals and output terminals.

10. The system of claim 1, wherein said schedule information includes the information about processing said order and the result for processing said order.

11. The system of claim 1, wherein said plurality of analyzing modules include the thermal analysis module, a circuit analysis module, a stress analysis module, a reliability analysis module, a material analysis module and a substrate analysis module.

12. A method for automatically providing online package entrusting comprises:
inputting an requiring information about a semiconductor package by a user;
storing said requiring information in a database;
producing a plurality of analysis results by a plurality of analysis modules according to said requiring information of said order;
recording said analysis results in said database; and
responding said analysis results to said user by a replying means.

13. The method of claim 12, wherein said user inputs said requiring information via internet.

14. The method of claim 12, wherein said requiring information includes a substrate type.

15. The method of claim 12, wherein said requiring information includes the die dimension.

16. The method of claim 12, wherein said requiring information includes a package type.

17. The method of claim 12, wherein said requiring information includes the thermal performance.

18. The method of claim 12, wherein said requiring information includes the number of a plurality of input terminals and a plurality of output terminals.

19. The method of claim 12, wherein said user receives said analysis results from said replying means by an electronic mail, a facsimile, a short message or all of that input terminals and output terminals

20. The method of claim 12, wherein said plurality of analyzing modules include the thermal analysis module, circuit analysis module, stress analysis module, reliability analysis module, material analysis module and substrate analysis module.
